(19) United States
(12) Patent Application Publication
(10) Pub. No.: US 2009/0300982 A1
(43) Pub. Date: Dec. 10, 2009

(54) CALCIUM CARBONATE SOIL AMENDMENT AND INDUSTRIAL FILLER DERIVED FROM CARPET BACKING

(75) Inventors: Lloyd Ballard Mauldin, Cartersville, GA (US); Jerry Allen Cook, Cartersville, GA (US)

Correspondence Address: CHEMICAL PRODUCTS CORPORATION, P.O. BOX 2470, 102 OLD MILL ROAD S.E., CARTERSVILLE, GA, 30120-1692, US

(73) Assignee: CHEMICAL PRODUCTS CORPORATION, Cartersville, GA (US)

(21) Appl. No.: 12/134,166

(22) Filed: Jun. 5, 2008

(51) Int. Cl. C09C 1/02; A01B 79/02

(52) U.S. Cl. 47/58.1 SC; 106/464

(57) ABSTRACT

The calcium carbonate component of waste carpet is concentrated by mechanical means and/or chemical means then subjected to a heat treatment at a temperature below the decomposition temperature of calcium carbonate to volatilize or modify organic compounds admixed with calcium carbonate so as to yield a free-flowing particulate filler composed of at least about 70% calcium carbonate.

### BACKGROUND

Most carpeting manufactured in the past 30 years consists of tufted nylon, polyester, or polypropylene carpet face fibers, held in place by a backing system containing calcium carbonate filler in a latex, EVA, PVC, or other polymer-based bonding system. Each year massive quantities of waste carpeting are ripped up and disposed of in municipal landfills when new flooring is installed in place of old carpeting. This massive stream of waste carpeting represents an opportunity for recovery of calcium carbonate from the carpet backings in addition to recovery of thermoplastic polymer from the carpet face fibers.

The composition of waste carpet is highly variable, but, on average, waste carpet is composed of approximately 50% by weight of tufted pile yarn face fibers, predominantly Nylon 6 and Nylon 6,6. Numerous patents teach methods to recover these Nylon 6 or Nylon 6,6 face fibers from waste carpet by chemical means while leaving other carpet components to be disposed of as a waste because of undesirable characteristics including a high content of Volatile Organic Compounds (VOCs). Mechanically recovered waste carpet backing materials also exhibit undesirable physical characteristics, such as very poor bulk powder flow characteristics caused by a tendency for the individual particles to stick together.

Physical processes to separate waste carpet face fibers from carpet backing involve shredding and grinding waste carpet, then separation of the denser, generally spherical particles of ground carpet backing containing high concentrations of calcium carbonate from the fibers which had constituted the face of the carpet. The ground carpet backing containing calcium carbonate as the predominant mineral filler is usually disposed of as a waste when separated from carpet face fibers because its very poor bulk flow characteristics as a result of the individual particles sticking together to each other make the material unusable in transportation, storage, and raw material feed systems designed to handle much more free-flowing mineral fillers such as newly-produced ground natural calcium carbonate.

U.S. Pat. Nos. 6,786,988; 6,814,826; 7,045,590; and U.S. patent application Ser. No. 10/956,143 (Publication Number 05/0042413); Ser. No. 10/827,417 (Publication 05/0008814) teach grinding waste carpet, and admixing this finely ground carpet, or the separated backing thereof, with a second filler material and then using this material as a filler in the manufacture of new carpet or other products which typically contain calcium carbonate filler, such as roofing materials, road paving materials, awnings, and tarps. The poor bulk flow characteristics of both fibrous ground whole carpet and ground carpet backing make use of these materials problematic without the design and installation of special transportation, storage, and raw material feed bulk handling equipment.

“Co-product” material from the Evergreen Nylon Recovery, LLC facility in Augusta, Ga. is taught in U.S. Pat. Nos 6,786,988 and 7,045,590; and U.S. patent application Ser. No. 10/827,417 (Publication 05/0008814) to be particularly useful as part or all of the filler for a backcoating for use in carpet manufacture because this material melts and becomes flowable at a relatively low temperature of around 150° C., thus enabling the application of a layer of the material onto a fiberglass backing normally used to stabilize a carpet tile where the material bonds to itself and to the fiberglass. The Evergreen Nylon Recovery facility processes only waste carpet which has Nylon 6 face fibers. The Nylon 6 face fibers are depolymerized and the resulting Caprolactam monomer is separated and recovered as the primary product. The “co-product” material from this facility, consisting of all components of the incoming waste carpet not depolymeized to Caprolactam and recovered, has been exposed to high temperatures and pressures and, as a result, has a strong odor and a high Volatile Organic Compound (VOC) content. Thus this “co-product” material, processed according to the teachings of U.S. Pat. Nos. 6,786,988 and 7,045,590; and U.S. patent application Ser. No. 10/827,417 (Publication 05/0008814) and applied in its molten state as a carpet backing, would be unacceptable because of its odor and high VOC content.

Thus a need exists for a practicable means of recovering calcium carbonate from the waste carpet destined for landfill disposal that can be used interchangeably with at least some of the newly-produced ground natural calcium carbonate materials found in commerce.

Both calcium carbonate and elemental carbon, in the form of charcoal or char, are beneficial agricultural soil additives. One of many presentations on the topic of the beneficial effects of elemental carbon in the form of charcoal or char on soil properties is “Charcoal as Soil Conditioner and Nutrient Retainer—Studies in the Humid Tropics, Amazonia, Brazil” presented at Energy and Agricultural Carbon Utilization: Sustainable Alternatives to Sequestration, University of Georgia Center for Continuing Education, Athens, Ga. held Jun. 10-11, 2004 by Christoph Steiner and Wolfgang Zech, Institute of Soil Science, University of Bayreuth, Bayreuth, Germany; Wenceslau G. Teixeira, Embrapa Amazonia Ocidental, Manaus, Brazil; and Johannes Lehmann, Department of Crop and Soil Sciences, Cornell University, Ithaca, N.Y. The use of calcium carbonate in agricultural applications is also well known in the art. Since World War II, increasing amounts of calcium carbonate materials have been spread on the soil of farms for soil neutralization as a method of increasing the productivity of the soil. The essential plant nutrients, calcium and magnesium, are supplied directly to the plants to support plant growth. Also, through calcium carbonate soil amendment, microbiological activity in the soil is stimulated, thereby liberating other available plant nutrients from the soil organic matter. U.S. patent application Ser. No. 10/792,252 (Publication Number 04/0168785) teaches the use of calcium carbonate derived from kraft pulp mill operations for agricultural soil amendment.

U.S. Pat. No. 5,846,378 (Phipps) and U.S. Pat. No. 6,830,615 (Lyons et al.) teach the preparation of calcium carbonate filler from the waste effluent of a paper-treating facility involving a heat treatment that decomposes up to 50% of the calcium carbonate to calcium oxide. U.S. Pat. No. 6,830,615 teaches the use of a carbonation step after heat treatment to convert the calcium oxide in the heat treated product back to calcium carbonate. The cost of suspending a particulate material in water, carbonation, filtration, and drying would make this process economically prohibitive for the production of a general purpose filler.

To promote the recycling of waste carpeting, a method of utilizing the backing components of waste carpeting as well as the polymeric face fibers is needed.

### SUMMARY OF THE INVENTION

It has been discovered that a free-flowing material predominantly composed of calcium carbonate and having a low Volatile Organic Compounds (VOCs) content can be produced from the backing component of collected waste carpet through heat treatment at temperatures low enough to avoid substantial decomposition of the calcium carbonate present in the carpet backing. Substantially all of the face fibers in the collected waste carpet must be separated from the backing component of collected waste carpet by mechanical means, chemical means, or a combination of both, prior to heat treatment of the backing component of collected waste carpet. The product of the present invention can have bulk handling characteristics similar to newly-produced ground calcium carbonate filler, in addition, the present invention can be practiced to produce a material with enhanced agricultural soil amendment benefits as a result of the presence of elemental carbon char.

### DETAILED DESCRIPTION OF THE INVENTION

In the process of the present invention, mechanical processes, chemical processes,or a combination of both mechanical and chemical processes are employed to separate collected waste carpet into at least one fraction predominantly composed of waste carpet face fibers and at least one fraction predominantly composed of waste carpet backing components, including at least calcium carbonate filler. Waste carpet fractions predominantly composed of backing components are heated to a temperature of between 400° C. and 800° C., preferably a temperature between 500° C. and 700° C., and most preferably to a temperature between 500° C. and 550° C. to obtain a particulate material predominantly composed of calcium carbonate with bulk flow characteristics similar to newly-produced ground natural calcium carbonate, a low Volatile Organic Compounds (VOC) content, and a calcium oxide content no greater than about 5% by weight.

To obtain a material destined for industrial filler use having a minimal carbon char content, this heat treatment is preferably conducted by continuously feeding the backing components of waste carpet to a rotary kiln designed for countercurrent flow, with the solid waste carpet backing components moving in one direction and the hot flue gases moving through the rotary kiln in the opposite direction. The amount of oxygen entering this rotary kiln must be limited to maintain an oxygen-free zone within the kiln as demonstrated by a high VOC content in the flue gases exiting the kiln. The rotary kiln must be equipped with an afterburner to destroy the VOCs in the flue gas stream exiting the kiln. The temperature of the gases exiting the rotary kiln is controlled to be substantially below the temperature of the gases exiting the afterburner. Heat is recovered from the gases exiting the afterburner by passing the gases through a heat recovery boiler. The gases exiting the heat recovery boiler are passed through a baghouse dust collector prior to being discharged to the environment.

To obtain a material destined for agricultural use in which a substantial carbon char content is desired, the process of the present invention can be conducted either as a batch process or as a continuous process. The process of the present invention performed in the absence of oxygen decomposes at least a portion of the organic compounds associated with the calcium carbonate in the waste carpet backing to form a char which makes the product of the present invention especially advantageous as a soil amendment. Heat treatment in a sealed vessel maximizes the amount of elemental carbon char formed.

In addition to dramatically improving the bulk flow characteristics of particulate materials derived from waste carpet backing, this heat treatment also serves to remove Volatile Organic Compounds (VOCs) which can be a component of some waste carpet backing materials as a result of those waste carpet backing materials having undergoing chemical separation processes to isolate them from the face fiber component of waste carpet. The process of the present invention can be performed in stages to allow removal of organic compounds volatilized at temperatures in the range of 300° C. to 800° C. in the absence of free oxygen, followed by exposure to an environment containing free oxygen to allow oxidation of some or all of the remaining non-volatile organic compounds and carbon char, thus substantially reducing the organic compound and carbon content of the resulting product of the present invention should this be desirable for specific industrial filler applications.

The present invention allows recycled calcium carbonate derived from waste carpet to be used as a direct replacement for newly mined and ground calcium carbonate in many agricultural and industrial applications including extruded carpet backing systems and other extruded thermoplastic and thermoset applications which employ calcium carbonate filler. This has the potential to significantly reduce the amount of landfilling or other waste disposal currently required for the backing component of waste carpeting.

It will be appreciated that the use of the product of the present invention derived from the backing of waste carpet material has applications other than in the agricultural and industrial applications specifically described. For example, the product of the present invention may be added as a filler to many of the products that typically employ calcium carbonate or other minerals as a filler. During any of the procedures described above, various conventional refinements may be employed. For example, grinding, pulverizing, or screening or other contaminate removal practices may be employed as desired to produce a product with the desired properties.

### EXAMPLES

### Example 1

A carpet backing component of collected waste carpet is obtained by shredding and grinding waste carpet followed by multiple screening processes to remove substantially all fibers.

A 6 inch deep layer of this carpet backing component is placed uniformly across the bottom in a plastic 3 gallon pail, a second identical plastic 3 gallon pail is filled with water and placed inside the pail containing the 6 inch deep layer of carpet backing component. After 72 hours the pail filled with water is removed and the pail containing the layer of carpet backing component is turned onto its side; the layer of carpet backing component does not move, it maintains a 90 degree angle of repose in the pail turned onto its side. This demonstrates the extremely poor bulk material handling characteristics of this carpet backing component prior to the practice of the present invention.

This carpet backing component material is placed into multiple uncovered crucibles and heated in a laboratory muffle furnace to 450° C. for several hours, a substantial volume of acrid smoke is generated during this heating process. The bulk density of the material in the crucibles increases during the heating process and the particulate material in the crucibles is black immediately after smoke generation has ceased. The color of the particulate material in the uncovered crucibles changes from black to light tan as it is held at 450° C. in the laboratory muffle furnace.

After heat treatment and cooling, the carpet backing component material is placed uniformly across the bottom in a plastic 3 gallon pail to form a 6 inch deep layer, a second identical plastic 3 gallon pail is filled with water and placed inside the pail containing the 6 inch deep layer of carpet backing component. After 72 hours the pail filled with water is removed and the pail containing the layer of heat treated carpet backing component material is turned onto its side; the heat treated carpet backing component flows out of the bucket forming about a 30 degree angle of repose. This demonstrates that the product of the present invention exhibits dramatically improved bulk material handling characteristics.

### Example 2

A carpet backing component is obtained by depolymerizing the Nylon 6 face fibers from collected waste carpet containing only Nylon 6 face fibers. At the temperature utilized for depolymerization of the Nylon 6 face fiber, the carpet backing components and residual Nylon 6 oligomers form a thick molten mass which is formed into a thin sheet, cooled to form a solid sheet, and crushed to form carpet backing component chips. These carpet backing component chips are composed of about 70% calcium carbonate, have a strong unpleasant odor, and contain Volatile Organic Compounds (VOC) as a result of the chemical process employed to separate substantially all of the face fibers from the carpet backing component chips. When these carpet backing component chips are ground and incorporated into an extruded polyolefin sheet replacing half of the mineral filler content of the sheet to simulate a polyolefin backing component of carpet tiles, the resulting extruded polyolefin sheet is found to have an unacceptable odor and a high Volatile Organic Compounds (VOC) content.

The aforesaid carpet backing component chips are subjected to the process of the present invention through a rotary kiln operated in continuous countercurrent mode, with a natural gas burner heating the incoming gases at the end of the kiln from which the non-volatile components of the aforesaid carpet backing component chips are discharged. The carpet backing component chip feed rate and oxygen content of the gases passing through the kiln are controlled to keep a visible flame zone in the center section of the rotary kiln. The gas stream exiting the kiln contains a substantial concentration of volatile organic compounds and is opaque due to the presence of black smoke resulting from incomplete combustion and volatilization followed by condensation of organic compounds in the anoxic section of the kiln between the flame front located in the center section of the rotary kiln and the end of rotary kiln where flue gases exit the kiln and the carpet backing component chips are introduced into the kiln.

The non-volatile components of the aforesaid carpet backing component chips exit the rotary kiln as a gray free-flowing powder. When these non-volatile components of the aforesaid carpet backing component chips are ground to pass through a 120 mesh U.S. Standard sieve and then incorporated into an extruded polyolefin sheet replacing half of the mineral filler content of the sheet to simulate a polyolefin backing component of carpet tiles, the resulting extruded polyolefin sheet is found to be essentially odorless and a has an low VOC content.

While the invention has been herein shown and described in what is presently conceived to be its most practical and preferred embodiment, it will be apparent to those skilled in the art that many modifications may be made thereof within the scope of the invention, which scope is to be accorded the broadest interpretation of the appended claims so as to encompass all equivalent products and processes.

What is claimed is:

1. A method for preparing a free-flowing particulate filler material composed predominantly of calcium carbonate from a backing component of waste carpeting containing calcium carbonate useful as a filler material in industrial applications comprising:
a) collecting waste carpeting;
b) separating a backing component containing calcium carbonate from the face fiber component of the aforesaid collected waste carpeting by subjecting aforesaid collected waste carpeting to:
i) one or more mechanical comminution processes followed by one or more physical separation processes to separate aforesaid collected waste carpeting into at least 2 physically and chemically distinct fractions one of which contains substantially all of the backing; or
ii) one or more chemical processes to render one or more polymeric components of the face fibers in the aforesaid collected waste carpet separable from the backing component of aforesaid collected waste carpet including dissolution or depolymerization of one or more polymeric components of the face fiber component of the aforesaid collected waste carpeting, followed by separation of the one or more polymeric components of the face fibers in the aforesaid collected waste carpet from the backing component of aforesaid collected waste carpeting; or
iii) a combination of mechanical and chemical processes to separate the aforesaid collected waste carpeting into at least 2 fractions, one of which contains substantially all of the bacing component from the aforesaid collected waste carpeting;
c) heating the backing component from the aforesaid collected waste carpeting to a temperature above about 400 degrees C. but below about 800 degrees C. for a time sufficient to remove substantially all volatile organic compounds from the backing component of the aforesaid collected waste carpeting.

2. A method according to claim 1 wherein a backing component containing calcium carbonate is separated from collected waste carpeting by shearing face fibers from the aforesaid collected waste carpeting and removing the sheared face fibers from the intact carpet backing component.

3. A method according to claim 1 wherein in step b) a backing component containing calcium carbonate is obtained by shredding and grinding collected waste carpeting then subjecting the ground collected waste carpeting to one or more mechanical screening processes to separate denser, more spherical particles derived from the carpet backing from less dense, polymeric fibrils derived from the face fiber component of the aforesaid collected waste carpeting.

4. A method according to claim 1 wherein in step b) a backing component containing calcium carbonate is obtained by subjecting collected waste carpeting containing Nylon 6 face fibers to elevated temperatures and pressures in the presence of steam sufficient to depolymerize the Nylon 6 face fibers to Caprolactam monomer followed by separation of substantially all of the aforesaid Caprolactam monomer from the backing component of the aforesaid collected waste carpeting.

5. A method for preparing a free-flowing particulate filler material containing at least about 90% calcium carbonate from waste carpeting comprising:
a) collecting waste carpeting composed of a backing system containing calcium carbonate and face fibers composed of one or more polymeric materials;
b) separating the aforesaid collected waste carpeting into at least 2 fractions by chemical or mechanical means, or a combination of chemical and mechanical means, such that one fraction contains a substantially higher concentration of calcium carbonate than the aforesaid collected waste carpeting; and
(c) heating the collected waste carpeting fraction containing a substantially higher concentration of calcium carbonate than the aforesaid collected waste carpeting to a temperature between about 400 degrees C. and about 800 degrees C. while limiting the exposure of the aforesaid collected waste carpeting to oxygen to remove a substantial proportion of the organic material contained in the calcium carbonate enriched component while decomposing less that 1% of the contained calcium carbonate.

6. A method according to claim 5 wherein step (c) is performed in a rotary kiln.

7. A method according to claim 5 wherein in step (a) the waste carpeting collected is composed of a backing system containing calcium carbonate and face fibers composed of Nylon 6.

8. A method according to claim 5 wherein in step (a) the waste carpeting collected is composed of a backing system containing calcium carbonate and face fibers composed of Nylon 6,6.

9. A method for preparing a free-flowing particulate filler material predominantly composed of calcium carbonate from waste carpeting comprising:
a) collecting waste carpeting composed of a backing containing calcium carbonate and face fibers composed of Nylon 6;
b) subjecting the aforesaid collected waste carpeting to chemical processing to depolymerize substantially all of the Nylon 6 face fibers to Caprolactam;
c) separating Caprolactam from the aforesaid collected waste carpeting subjected to chemical processing to obtain a material derived from the waste carpeting backing component containing calcium carbonate; and
d) heating the material derived from the waste carpeting backing component containing calcium carbonate to a temperature between about 400 degrees C. and about 800 degrees C. at or below atmospheric pressure for a time sufficient to substantially reduce the hydrocarbon content of the material derived from the waste carpeting backing component containing calcium carbonate while decomposing less than about 5% of the contained calcium carbonate.

10. A method according to claim 9 wherein after step c but before step d the material derived from the waste carpeting backing component containing calcium carbonate is formed into solid flakes, chips, or particulates.

11. A method according to claim 10 wherein the material derived from the waste carpeting backing component containing calcium carbonate formed into solid flakes, chips, or particulates prior to being subjected to step d is stored in a bin or silo prior to being subjected to step d.

12. A method for producing a free-flowing particulate filler material predominantly composed of calcium carbonate from waste carpeting comprising:
a) collecting waste carpeting composed of a backing containing calcium carbonate and face fibers composed of Nylon 6;
b) subjecting the aforesaid collected waste carpeting to chemical processing to depolymerize substantially all of the Nylon 6 face fibers to form Caprolactam;
c) separating Caprolactam from the aforesaid collected waste carpeting subjected to chemical processing to obtain a carpeting component composed primarily of backing containing calcium carbonate;
d) forming the carpeting component composed primarily of backing containing calcium carbonate into solid flakes, chips, or particulates;
e) introducing solid flakes, chips, or particulates composed primarily of carpet backing containing calcium carbonate into a rotary kiln to heat said flakes, chips, or particulates to a temperature between about 400 degrees C. and about 800 degrees C. to produce a gas phase containing at least some volatile organic compounds and a solid phase composed predominantly of calcium carbonate;
f) separating the gas phase containing at least some volatile organic compounds from the solid phase composed predominantly of calcium carbonate;
g) introducing the gas phase containing at least some volatile organic compounds to an afterburner apparatus to substantially decrease the concentration of volatile organic compounds in said gas phase while substantially increasing the temperature of said gas phase to form a high temperature exhaust gas phase; and
h) passing the aforesaid high temperature exhaust gas phase through a heat recovery boiler to obtain steam for industrial use.

13. A method for adjusting and enhancing the pH of soil while simultaneously enhancing the soil characteristics with elemental carbon, comprising the steps of:
a) collecting waste carpeting composed of a backing system containing calcium carbonate and face fibers composed of one or more polymeric materials;
b) separating the aforesaid collected waste carpeting into at least 2 fractions by chemical or mechanical means, or a combination of chemical and mechanical means, such that substantially all of the calcium carbonate contained in the aforesaid waste carpeting is contained in one of the aforesaid fractions; and
c) heating the aforesaid fraction containing substantially all of the calcium carbonate contained in the aforesaid waste carpeting to a temperature between about 400 degrees C. and about 800 degrees C. in the absence of air to form an admixture of calcium carbonate and carbonaceous char;
d) admixing an effective amount of water with the admixture of calcium carbonate and carbonaceous char with sufficient agitation to provide a sprayable calcium carbonate and carbonaceous char slurry; and
e) spraying an effective amount of the sprayable calcium carbonate and carbonaceous char slurry onto the soil to adjust the pH of the soil and increase the elemental carbon content of the soil.
